(19) United States
(12) Patent Application Publication
(10) Pub. No.: US 2026/0133310 A1
(43) Pub. Date: May 14, 2026

(54) METHOD FOR OPERATING A SENSOR DEVICE

(71) Applicant: Hella GmbH & Co. KGaA, Lippstadt (DE)

(72) Inventors: Etienne Costa-Patry, Berlin (DE); Vivek Bakul Maru, Berlin (DE); Piyush Shukla, Berlin (DE)

(21) Appl. No.: 19/380,632

(22) Filed: Nov. 5, 2025

(30) Foreign Application Priority Data
Nov. 11, 2024 (DE) 102024132771.5

(51) Int. Cl. G01S 13/58; G01S 7/41; G01S 13/02; G01S 13/56; G01S 13/70

(52) U.S. Cl. CPC G01S 13/582; G01S 7/414; G01S 13/0209; G01S 13/56; G01S 13/70

(57) ABSTRACT

A method is provided for operating a sensor device based on radar technology, preferably UWB radar technology, for various vehicle functions outside and/or inside a vehicle. A radar measurement (CIR) provides time-of-flight information from which a location (Tap) of a potential target (Z) can be derived. Successive radar measurements (CIRs) show differences in time-of-flight information from which a movement (e.g. speed of a potential target (Z) at a location (Tap)) are derived.

### CROSS REFERENCE

This application claims priority to German Application No. 10 2024 132771.5, filed Nov. 11, 2024, the entirety of which is hereby incorporated by reference.

### FIELD OF THE INVENTION

The invention relates to a method for operating a sensor device based on radar technology, preferably UWB radar technology. The invention also relates to a corresponding computer program, control unit, and sensor device, in particular a UWB sensor device, for executing the method.

### BACKGROUND OF THE INVENTION

UWB sensor devices with radar functions that are used in vehicles (normally one unit for each row of seats, although any number can be used), and outside the vehicle (normally one unit on each corner) can be used for various vehicle functions inside and/or outside the vehicle. These functions include, e.g. detection of a break-in, remote access, object tracking, e.g. vehicles and/or people outside the vehicle, identifying objects, e.g. children and/or animals, inside the vehicle, etc. In general, UWB sensor devices can be used to identify, locate, track, and classify movements of passive objects (people, animals, vehicles, etc.). These objects do not necessarily have to communicate with the UWB sensor device.

UWB radar measurements can be described with regard to fast time. A radar measurement that provides time-of-flight information can be evaluated to determine a location (frequently referred to as a “Tap”). UWB radar measurements can also be described with regard to slow time. In this case, numerous successive radar measurements (“channel impulse responses” or CIRs) can be evaluated to determine changes in signals at each location. An analysis of the fast time can be used to determine a location. An analysis of the slow time can be used to detect movement.

The standard approach for analyzing slow time involves converting the analysis the frequency range, e.g. using a fast Fourier transformation. To precisely determine the dominant frequencies, and thus speeds, in the radar measurements, these analyses require a high sampling frequency and a large number of data points, which may not be available in UWB radar applications. Furthermore, the subsequent computing is complicated.

### BRIEF SUMMARY OF THE INVENTION

The object of the present invention is to therefore at least partially resolve at least one of the above disadvantages. Specifically, the object of the invention is to create a better method for operating a sensor device based on radar technology, preferably UWB radar technology. Ideally, the invention results in a simple, quick and efficient means of analyzing movement in order to determine whether there is relevant information obtained in slow time at a specific location that needs to be processed. It is also the object of the invention to create a corresponding computer program, control unit, and sensor device, in particular a UWB sensor device, for carrying out the method.

These problems are solved by a method that has the features of the independent claim. They are also solved by a computer program, control unit, and sensor device, in particular a UWB sensor device, which have the features of the coordinate independent claims. Any of the features and details described in the context of the different embodiments and/or aspects of the invention apply to the other embodiments and/or aspects, and vice versa, such that reciprocal reference can be made to the disclosures of individual embodiments and/or aspects.

The invention results in a method for operating a sensor device based on radar technology, preferably UWB radar technology, for various vehicle functions outside and/or inside a vehicle.

There can be one or more sensor devices for each row of seats in a vehicle. There can also be one or more sensor devices at each corner and/or on each side of the outside of the vehicle.

Possible vehicle functions include, e.g. detection of break-ins, remote access, tracking objects, e.g. vehicles and/or people, outside the vehicle, identifying objects, e.g. children and/or animals, inside the vehicle, etc.

Numerous successive radar measurements can be taken with the sensor device. A radar measurement comprises emitting a transmission signal (e.g. a UWB signal pulse) and/or receiving a signal reflected on a potential target.

An identified target can be an object. Possible objects outside the vehicle include, e.g. vehicles, bicycles, scooters, people, etc. Possible objects inside the vehicle include, e.g. people, children, animals, etc.

A radar measurement can provide time-of-flight information from which the location (often referred to as a “Tap”, one of which can be approx. 15 cm) of a potential target can be determined.

Successive radar measurements can contain changes in flight-of-time information from which movement, e.g. the speed, of a potential target at a location can be derived.

The proposed method contains the following steps: selecting a location in a radar measurement; recording successive radar measurements for the specific location; determining a significance value for the selected location in the successive measurements; and evaluating the selected location as significant or insignificant for further analysis, e.g. to determine movement of a potential target at this location based on the significance value.

The method can be used to quickly and easily determine whether relevant information at a specific location obtained in slow time is available for further movement analysis. The amount of information, or data, for the further movement analysis in slow time can be reduced to as little as 10% thereof. A simple, quick, and efficient analysis of the slow time signals can be obtained in this way. This results in a better method for operating a sensor device, which requires little computing, and less memory.

The idea advantageously makes use of the following observations: random noise is unrelated to time; if nothing relevant takes place at a specific location (specific Tap), the slow time signals rows are dominated by random noise; and if something relevant takes place at a specific location, the slow time signal rows contain time-dependent structures.

The significance value in the context of the invention can be defined as a function, e.g. a relationship between, or variation (e.g. standard deviation, variance, etc.) in data values in the CIRs (number n of CIRs in a specific time period) and a variation in differences between the data values in the CIRs.

The significance value (or SignificantScore (SW)) for a selected location can be expressed with the following formula:

$$SignificantScore = \frac{\sqrt{\frac{1}{n} {{Σ}_{i = 1}^{n} ( {CIR}_{i} - {CIR}_{mean} )}^{2}}}{\sqrt{\frac{1}{n} {{Σ}_{i = 1}^{n} ( Δ {CIR}_{i} - Δ {CIR}_{mean} )}^{2}}}$$

In which: CIRᵢ is the CIR with the number i, wherein i=1, 2, . . . n, wherein n is the number of radar measurements; CIRₘₑₐₙ is the mean value of the number n of CIRs; ΔCIRᵢ is the difference between two successive CIRs; and ΔCIRₘₑₐₙ is the mean value of the differences between successive CIRs.

To determine whether there is significant information at a specific location (Tap), the following evaluation can be carried out.

When a typical signal change between two successive CIRs at a specific location is the same as the typical signal change over numerous CIRs in a UWB signal, this location contains no movement information.

If instead, a typical signal change between two successive CIRs at a specific location is greater than the typical signal changes over numerous CIRs, this location may contain important information.

The method can also be repeated for different locations, e.g. for all available locations in the radar measurements. Consequently, different locations can be evaluated for relevant movement information to select only the relevant locations and thus reduce the amount of information for further analysis.

Furthermore, the recording of successive radar measurements for the specific location can be carried out for a specific number of successive measurements. This makes it possible to analyze signals obtained in slow time.

The significance value can used to distinguish between normal background noise and specific temporal sequences (which have frequencies that can be determined) in the successive radar measurements. Consequently, it is possible to distinguish between normal background noise and relevant movement information.

The significance value can be determined as a function of or a relationship between a variation in data values in the successive radar measurements and a variation in differences between the data values in successive radar measurements.

This method, which comprises determining the significance value and/or evaluating the selected location as significant or insignificant for further analysis, can be carried out using a machine learning method. This requires less computing and less memory. Furthermore, the machine learning method can accurately and efficiently detect temporal relationships and/or frequencies in signals, such that a complicated analysis using fast Fourier transformation is unnecessary.

Further analysis can also be carried out at preferably the best location that has been evaluated as significant. Consequently, just one, or the best, location can be used for the movement analysis.

Up to four locations can be selected as significant for further analysis. This reduces the amount of data for further analysis, and ensures that potential targets are reliably identified, even in uncertain conditions.

It may also be advantageous when enough locations are selected as significant by the method to reduce the amount of data for further analysis acquired by successive radar measurements to as little as 10% of the total. This results in a balanced solution for reducing the amount of data and reliably identifying potential targets.

The significance value can also have a threshold value, based on which the selected location is regarded as significant or insignificant. This results in a quick and simple evaluation of selected locations.

Furthermore, a position of a potential target in relation to the vehicle, which can be inside or outside the vehicle, can be taken into account when evaluating the selected location as significant or insignificant for a desired vehicle function inside and/or outside the vehicle. This results in a simple additional criterium for determining whether a potential target is important for the desired vehicle function. By way of example, it can be determined that potential targets outside the vehicle can be ignored when determining if there is a child inside a parked car, which are then not evaluated in the slow time.

It may be advantageous to ignore potential targets outside the vehicle for vehicle functions inside the vehicle.

The method can also be used to track objects, e.g. vehicles and/or people that are outside and/or inside the vehicle.

It may be advantageous to ignore potential targets inside the vehicle for vehicle functions outside the vehicle.

It may also be advantageous to take certain measures such as activating an external camera, switching on a light, issuing an alarm, etc. if erratic behavior of an object is detected when tracking objects outside the vehicle.

It may also be advantageous to check the identity of someone entering the vehicle. This results in a reliable and convenient means of controlling keyless access to the vehicle.

The method can be used to operate numerous sensor devices. This results in an deeper analysis.

The information acquired by numerous sensor devices can be combined to more reliably and conveniently enable various vehicle functions outside and/or inside the vehicle.

The invention also results in a computer program that contains commands with which the method can be executed by a computer when the program is run thereon. This results in the same advantages that are obtained with the method described above. Reference is made to these advantages in their entirety at this point.

The invention also results in a control unit that contains a memory in which code is stored, and a computer that executes the method described above when the code is executed by the computer. This results in the same advantages obtained with the method. Reference is made to these advantages in their entirety at this point.

In particular, when the method is executed for operating numerous sensor devices, one control unit for one of the sensor devices can have a master function, which then combines the information from numerous sensor devices.

Fundamentally, numerous control units can each have an evaluation function with which information from numerous sensor devices are combined independently.

The invention also results in a sensor device, in particular a UWB sensor device, that has a corresponding control unit that is designed to execute the method described above. This results in the same advantages as those obtained with the method described above. Reference is made to these advantages in their entirety at this point.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows an exemplary vehicle with numerous sensor devices.

FIG. 2 shows exemplary radar measurements for numerous locations.

FIG. 3 shows exemplary radar measurements for one location.

FIG. 4 shows exemplary significance values for numerous radar measurements, each for one location.

FIG. 5 shows an exemplary sequence of the proposed method.

### DETAILED DESCRIPTION OF THE DRAWINGS

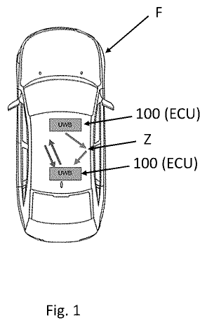

FIGS. 1 to 5 illustrate the proposed idea, in which a method for operating a sensor device 100 based on radar technology, preferably UWB radar technology, can be used for various vehicle functions outside and/or inside a vehicle F.

There can be at least one sensor device 100 for each row of seats in the vehicle F (see FIG. 1). There can also be at least one sensor device 100 on each corner and/or side of the outside of the vehicle F.

These vehicle functions that can be obtained with the sensor device 100 include detecting break-ins, remote access, tracking objects, e.g. vehicles or people outside the vehicle F, identifying objects, e.g. children and/or animals inside the vehicle F, etc.

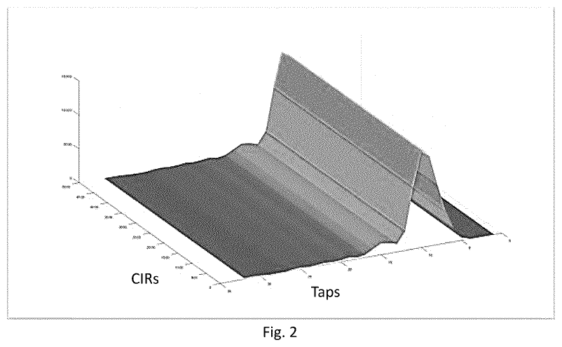

Numerous radar measurements CIRs can be successively carried out with the sensor device 100 (see FIG. 2). A radar measurement CIR can comprise emitting a transmission signal (e.g. a UWB signal pulse) and/or receiving a signal reflected on a potential target (e.g. a reflected UWB signal pulse).

An identified target can be an object. Possible objects outside the vehicle can be vehicles, bicycles, scooters, people, etc. Possible objects inside the vehicle can be people, children, animals, etc.

A radar measurement CIR can provide time-of-flight information from which the location (frequently referred to as a Tap, wherein one Tap can be approx. 15 cm) of a potential target Z can be derived (see FIG. 2).

Successive radar measurements CIRs can show changes in time-of-flight information from which the movement, e.g. speed, of a potential target Z at a location (Tap) can be derived (see FIG. 2).

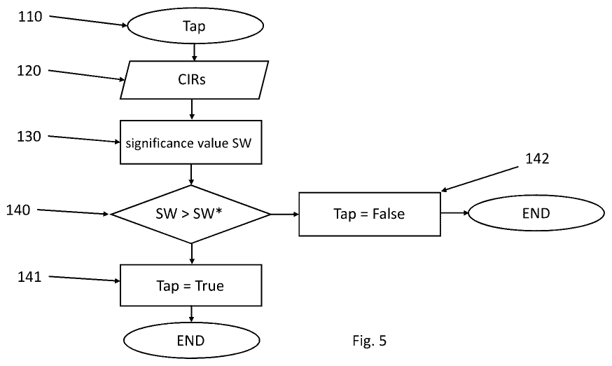

As shown in FIG. 5, the method can contain the following steps: 110—selecting a location (Tap) in a radar measurement CIR; 120—recording successive radar measurements CIRs for the specific location (Tap); 130—determining a significance value SW for the selected location (Tap) in the successive radar measurements CIRs; and 140—evaluating the selected location (Tap) as significant (true—see step 141) or insignificant (false—see step 142) for further analysis, e.g. to determine movement of a potential target Z at this selected location (Tap) based on the significance value SW.

Using the method, it is possible to quickly and easily determine whether relevant information can be obtained in slow time for further analysis of the movement at a specific location (Tap). The method can be used advantageously to reduce the amount of information or data for further analysis of the movement in the slow time to as little as 10% of the overall amount.

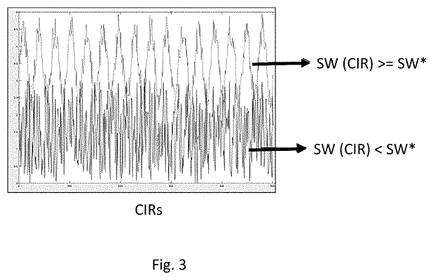

The following is taken into account for this: random noise is unrelated to time; if nothing relevant takes place at a specific location (specific Tap), the slow time signal rows are dominated by random noise (see bottom of FIG. 3); and if something relevant takes place at a specific location (Tap), the slow time signal rows contain time-dependent structures.

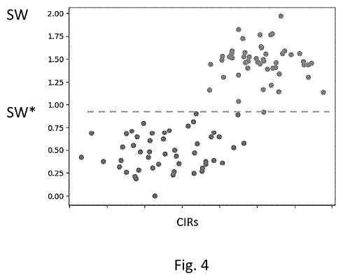

The significance value (SW, see FIG. 4) as set forth in the invention, can be understood as a function, e.g. a relationship, or variation (e.g. standard deviation, variance, etc.) of data values in the CIRs (number n of CIRs in a specific time period) and a variation in differences in the data values in the CIRs.

To determine whether a specific location (Tap) contains significant information, the following evaluation can be carried out.

If a typical signal change in a UWB signal between two successive CIRs at a specific location (Tap) is the same as the typical signal change in numerous CIRs, this location (Tap) contains no movement information (see bottom of FIG. 3).

If a typical signal change between two successive CIRs at a specific location (Tap) is greater than the typical signal change in numerous CIRs, this location (Tap) may contain important movement information (see top of FIG. 3).

The method can advantageously be repeated for different locations (Taps), preferably for all available locations (Taps) in the radar measurements CIRs, to find relevant locations (Taps) for further analysis.

As a rule, a number n of successive radar measurements CIRs can be carried out for the specific location (Tap).

Advantageously, the significance value SW can be used to distinguish between normal background noise and specific temporal sequences (containing frequencies that can be determined, for example) in the successive radar measurements CIRs.

The significance value SW can be determined based on, or as a relationship between, a variation in data values in the successive radar measurements CIRs and a variation in differences in the data values in the successive radar measurements CIRs.

The significance value (“SignificantScore” (SW)) for a selected location (Tap) can be expressed with the following formula:

$$SignificantScore = \frac{\sqrt{\frac{1}{n} {{Σ}_{i = 1}^{n} ( {CIR}_{i} - {CIR}_{mean} )}^{2}}}{\sqrt{\frac{1}{n} {{Σ}_{i = 1}^{n} ( Δ {CIR}_{i} - Δ {CIR}_{mean} )}^{2}}}$$

In which: CIRᵢ is the CIR with the number i, wherein i=1, 2, . . . n, wherein n is the number of radar measurements; CIRₘₑₐₙ is the mean value of the number n of CIRs; ΔCIRᵢ is the difference between two successive CIRs; and ΔCIRₘₑₐₙ is the mean value of the differences between successive CIRs.

The method, in particular determining the significance value (SW) and/or evaluating the selected location (Tap) as significant (true) or insignificant (false) for further analysis, can be carried out using a machine learning method, to reliably and efficiently detect temporal relationships and/or frequencies in (UWB) signals.

By way of example, further analysis is only carried out at a preferably best location (Tap), that has been determined to be significant (true).

By way of example, up to four locations (Taps) can be selected as significant for further analysis.

It may be advantageous to select as many locations (Taps) as significant with the method to reduce the amount of data for further analysis to as little as 10% of the total amount of data.

As shown in FIG. 4, a threshold value SW* can be determined for the significance value SW, based on which the selected location (Tap) is determined to be significant (true) or insignificant (false).

The position of a potential target Z in relation to the vehicle F, which can be inside or outside the vehicle F, can be taken into account in the method. Consequently, when determining if there is a child inside a parked car, any potential targets outside the vehicle F can be ignored, and not evaluated with regard to the slow time.

As a rule, for vehicle functions inside the vehicle F, potential targets outside the vehicle F can be ignored.

The method can also be used advantageously to track objects, e.g. vehicles and/or people, outside and/or inside the vehicle F.

As a rule, any potential targets inside the vehicle F can be ignored for vehicle functions outside the vehicle F.

If erratic behavior of an object is detected when tracking objects outside the vehicle F, measures such as activating an external camera, switching on a light, issuing an alarm, etc. can be initiated.

The method can be used to track an object entering the vehicle F, in order to check the identity thereof, e.g. for a secure and convenient keyless access check.

The method can also be used to operate numerous sensor devices 100.

Information from numerous sensor devices 100 can be combined make various vehicle functions outside and/or inside a vehicle F more reliable and convenient.

Other aspects of the invention relate to a computer program, control unit ECU, and sensor device 100, in particular a UWB sensor device.

The above description of the drawings only describes examples of the present invention. Individual features of the embodiments can be combined freely, if it makes sense, without abandoning the scope of protection for the invention.

### LIST OF REFERENCE SYMBOLS

100 sensor device
F vehicle
Z target
Tap location
Taps locations
CIR radar measurement
CIRs radar measurements
SW significance value
SW* threshold value
true significant
false insignificant
n number
ECU control unit

1. A method for operating a sensor device based on radar technology for various vehicle functions outside and/or inside a vehicle, wherein a radar measurement provides time-of-flight information from which a location of a potential target can be derived, wherein successive radar measurements show changes in time-of-flight information, from which the movement of a potential target at a location can be derived, the method comprising:
selecting a location in a radar measurement;
recording successive radar measurements for that location;
determining a significance value for the location in the successive radar measurements; and
evaluating the location as significant (true) or insignificant (false) for further analysis based on the significance value.

2. The method according to claim 1, wherein the method is repeated for various locations, and/or wherein successive radar measurements for the location are recorded until a specific number (n) of successive radar measurements have been made.

3. The method according to claim 2, wherein the significance value distinguishes between normal background noise and specific temporal sequences of the successive radar measurements, and/or wherein the significance value is based on the relationship between a variation in data values in the successive radar measurements and variations in the differences of the data values in successive radar measurements.

4. The method according to claim 1, wherein the determination of the significance values and/or evaluation of the location as significant (true) or insignificant (false) for further analysis, makes use of a machine learning method.

5. The method according to claim 1, wherein further analysis is carried out at the best location that has been evaluated as significant (true).

6. The method according to claim 2, wherein up to four locations are selected as significant (true) for carrying out further analysis.

7. The method according claim 2, wherein enough locations are selected by the method as significant (true) that an amount of data for further analysis is reduced to 10% of the total amount of data are obtained using the successive radar measurements.

8. The method according to claim 1, wherein a threshold value is determined for the significance value based on which the location is regarded as significant (true) or insignificant (false).

9. The method according to claim 1, wherein a position of a potential target in relation to the vehicle is taken into account when determining whether the selected location is significant (true) or insignificant (false) for a desired vehicle function inside and/or outside the vehicle and/or wherein potential targets outside the vehicle are ignored for vehicle functions inside the vehicle.

10. The method according to claim 1, wherein the method is use to track objects outside and/or inside the vehicle, and/or wherein potential targets inside the vehicle are ignored for vehicle functions outside the vehicle, and/or wherein when erratic behavior of an object that is being tracked outside the vehicle is detected, an action is taken, and/or wherein when tracking an object entering the vehicle, its identity is checked.

11. The method according to claim 1, wherein numerous sensor devices are operated, wherein information acquired from the numerous sensor devices is combined for vehicle functions outside and/or inside a vehicle.

12. A control unit that contains a non-transitory computer-readable medium in which code is stored, and a computer, wherein the method according to claim 1 is carried out when the code is executed by the computer, wherein a control unit (ECU) for at least one sensor device has a master function, or numerous control units (ECU) each have an evaluation function, for acquiring information from the at least one sensor device when executing the method for operating numerous sensor devices.

14. A sensor device which contains a control unit (ECU) according to claim 13.

15. The method according to claim 1, wherein the radar technology is UWB radar technology.

16. The method according to claim 1, wherein the further analysis includes determining the movement of a potential target at the location.

17. The method according to claim 9, wherein the position of the potential target is inside the vehicle.

18. The method according to claim 10, wherein the action includes one or more of: an external camera is activated, a light is switched on, or an alarm is issued.
